(19) United States
(12) Patent Application Publication
(10) Pub. No.: US 2013/0335538 A1
(43) Pub. Date: Dec. 19, 2013

(54) MULTIPLE VIEWPOINT IMAGE DISPLAY DEVICE

(71) Applicants: Sergey Shestak, Suwon-si (KR); Dae-sik Kim, Hwaseong-si (KR); Kyung-hoon Cha, Yongin-si (KR)

(72) Inventors: Sergey Shestak, Suwon-si (KR); Dae-sik Kim, Hwaseong-si (KR); Kyung-hoon Cha, Yongin-si (KR)

(73) Assignee: SAMSUNG ELECTRONICS CO., LTD., Suwon-si (KR)

(21) Appl. No.: 14/003,127

(22) PCT Filed: Mar. 2, 2012
(86) PCT No.: PCT/KR12/01588

§ 371 Date: Sep. 4, 2013

Related U.S. Application Data
(60) Provisional application No. 61/449,221, filed on Mar. 4, 2011.

(51) Int. Cl. H04N 13/04

(52) U.S. Cl. CPC H04N 13/0409
USPC 348/54

(57) ABSTRACT

A multi-viewpoint image display device is provided, which includes an image panel including a plurality of pixels configured to be arranged in a plurality of rows and columns, a backlight unit configured to provide light to the image panel, a parallax portion configured to be arranged in front of the image panel, and a mask portion configured to be arranged between the image panel and the backlight unit to partially mask the plurality of pixels. Accordingly, resolution balance can be matched without interference.

### CROSS-REFERENCE TO RELATED APPLICATIONS

This application is a National Stage application under 35 U.S.C. §371 of PCT/KR2012/001588 filed on Mar. 2, 2012, which claims priority from U.S. Provisional Application No. 61/449,221, filed on Mar. 4, 2011, in the United States Patent and Trademark Office, the disclosures of which are incorporated herein by reference in their entirety.

### BACKGROUND

1. Field

The exemplary embodiments relate generally to a multi-viewpoint image display device, and more particularly to a multi-viewpoint image display device, which performs partial masking of pixels using a mask area.

2. Description of Related Art

With the development of electronic technology in the related art, various types of electronic devices have been developed and distributed. Particularly, in the last several years, display devices, such as Televisions (TVs) have been developed quickly.

As the performances of display devices have been advanced, the types of content that are displayed on the display device have also been increased. In particular, stereoscopic three-dimensional (3D) display systems which can display 3D content have recently been developed and distributed.

3D display devices may be implemented not only by 3D TVs, but also diverse types of display devices, such as monitors, mobile phones, Personal Digital Assistants (PDAs), set-top Personal Computers (PCs), tablet PCs, digital photo frames, and kiosks. Further, 3D display technology may be used not only for home use, but also in diverse fields that require 3D imaging, such as science, medicine, design, education, advertisement, computer games, etc.

3D display systems are generally classified into a non-glasses type system that is viewable without glasses, and a glasses type system that is viewable through wearing of glasses. The glasses type system can provide a satisfactory 3D effect, but wearing glasses may cause inconvenience to a viewer. By contrast, the non-glasses type system has the advantage that the viewer can view a 3D image without glasses, and development of such a non-glasses type system has been continuously discussed.

FIG. 1 is a view illustrating the configuration of a non-glasses type 3D display device in the related art. Referring to FIG. 1, the 3D display device in the related art includes a backlight unit 10, an image panel 20, and a parallax portion 30.

The parallax portion may include a slit array of an opaque shield that is known as a parallax barrier or a lenticular lens array. In FIG. 1, the parallax portion is implemented by a lenticular lens array.

Referring to FIG. 1, the image panel 20 includes a plurality of pixels that are grouped into a plurality of columns. An image at a different viewpoint is arranged for each column. Referring to FIG. 1, a plurality of images 1, 2, 3, and 4 at different viewpoints are repeatedly arranged in order. That is, the respective pixel columns are arranged as numbered groups 1, 2, 3, and 4. A graphic signal that is applied to the panel is arranged in a manner that pixel column 1 displays a first image, and pixel column 2 displays a second image.

The backlight unit 10 provides light to the image panel 20. By light that is provided from the backlight unit 10, images 1, 2, 3, and 4, which are formed on the image panel 20, are projected onto the parallax portion 30, and the parallax portion 30 distributes the respective projected images 1, 2, 3, and 4 and transfers the distributed images in a direction toward the viewer. That is, the parallax portion 30 generates the respective projected images to be viewed at the viewer's position, that is, at a viewing distance. The thickness and diameter of a lenticular lens, in the case where the parallax portion is implemented by the lenticular lens array, and the slit spacing, in the case where the parallax portion is implemented by the parallax barrier, may be designed so that the respective projected images that are generated by the respective columns are separated by an average inter-pupillary distance of less than 65 mm. The separated images form respectively viewing areas. That is, as illustrated in FIG. 1, viewing areas 1, 2, 3, and 4 are formed.

In this state, if the user's left eye 51 is positioned in the viewing area 3 and the right eye 52 is positioned in the viewing area 2, the user can experience the 3D effect even without special glasses.

However, in the 3D display device in the related art, since a plurality of images are separated by vertical columns to be displayed, the vertical resolution is maintained, but the horizontal resolution is greatly reduced. For example, in the case where an XGA panel having 1024×768 resolution is applied to a 4-viewpoint 3D display device, the resolution becomes 256×768. As a result, the display has a full panel resolution in the vertical direction, but has ¼ resolution in the horizontal direction.

In order to solve this problem, U.S. Pat. No. 6,118,584 discloses that a loss of resolution between vertical and horizontal resolutions is dispersed through changing the pixel arrangement. However, this technology has the problem that a Liquid Crystal Display (LCD) panel in the related art having a general pixel arrangement is unable to be used for such technology.

Another method to solve the above-described problem is disclosed in U.S. Pat. No. 6,064,424. According to this method, however, due to the difference in arrangement between the pixel columns and the lenticular lens, light emitted from other pixels overlap each other, and crosstalk occurs between the images. “Crosstalk” refers to a phenomenon where the (N+1)-th or (N−1)-th image is mixed and shown through the user's right or left eye in addition to the N-th image. In this case, the same object is shown in other views, and if the crosstalk occurs, several contours of the object appear with blurring. Accordingly, if the crosstalk is increased, the picture quality is deteriorated.

According to the related art as described above, it is unable to effectively solve the above-described problem of the deterioration of the horizontal resolution.

### SUMMARY

Aspects of one or more exemplary embodiments have been made to address the above problems. Accordingly, an aspect of an exemplary embodiment provides a multi-viewpoint image display device, which can effectively disperse a loss of resolution between the vertical resolution and the horizontal resolution.

According to another aspect of an exemplary embodiment, a multi-viewpoint image display device includes an image panel including a plurality of pixels configured to be arranged in a plurality of rows and columns; a backlight unit configured to provide light to the image panel; a parallax portion configured to be arranged in front of the image panel; and a mask portion configured to be arranged between the image panel and the backlight unit to partially mask the plurality of pixels.

Here, the mask portion may include a plurality of mask areas configured to correspond to the plurality of pixels, each of the plurality of mask areas may be divided in a vertical direction into a light-transmitting area and a light-blocking area, and the light-blocking area may be arranged in a zigzag arrangement with respect to the pixels arranged in a row direction.

The light-blocking area may have a size of one half of a corresponding pixel, and the light-transmitting area may have a size of the other half of the corresponding pixel.

The plurality of mask areas may be sequentially aligned as a plurality of columns, and the direction of the zigzag arrangement of the light-blocking area may be alternatively reversed for each of the sequential columns of the respective mask areas.

Even in this case, the light-blocking area may have a size of one half of a corresponding pixel, and the light-transmitting area may have a size of the other half of the corresponding pixel.

The mask portion may include a plurality of mask areas configured to correspond to the plurality of pixels, each of the plurality of mask areas may be divided into a light-transmitting area and a light-blocking area, and the light-transmitting area may be formed in a diagonal direction in each of the plurality of mask areas.

The mask portion may include a plurality of mask areas configured to correspond to the plurality of pixels, each of the plurality of mask areas may be divided into a light-transmitting area and a light-blocking area, the light-transmitting area may be formed to be connected in a diagonal direction in at least two of the mask areas that are arranged in parallel in a row direction among the plurality of mask areas, and the light-blocking area may be formed in a remaining area except for the light-transmitting area in the mask area.

The mask portion may include a plurality of mask areas configured to correspond to the plurality of pixels, each of the plurality of mask areas may be divided into a light-transmitting area and a light-blocking area, the light-transmitting area may be formed in a diagonal direction in the plurality of mask areas, and the light-transmitting areas formed in the respective mask areas may be connected to each other.

The image panel may be a Ultra Definition (UD) panel that does not include a color filter.

The image panel may sequentially display color signals for each pixel according to a Field Sequential Color (FSC) method, and the backlight unit may provide a plurality of different color lights to the respective pixels in the image panel in synchronization with a display operation of the image panel.

The image panel may display a multi-viewpoint image by combining the plurality of pixels included in the plurality of continuous rows and columns.

The image panel may display a 12-viewpoint image through a 2×6 matrix by combining 6 pixels continuously arranged in a horizontal direction and two pixels continuously arranged in a vertical direction.

The parallax portion may include a lenticular lens of which a plurality of lens areas are arranged in a column direction, and a width of each of the lens areas corresponds to a width of each of the plurality of pixels.

The parallax portion may include a parallax barrier of which a plurality of barrier areas are arranged in a column direction, and a width of each of the barrier areas may correspond to a width of each of the plurality of pixels.

According to another aspect of an exemplary embodiment, there is provided a multi-viewpoint image display device, including: an image panel divided into a plurality of pixel units and configured to generate an image and including a plurality of pixels arranged in a matrix; a mask portion configured to mask a portion of each pixel of the plurality of pixels; and a parallax portion arranged in front of the mask portion and configured to generate a plurality of viewpoint images directed toward different viewpoints, wherein each of the plurality of pixel units may include a plurality of pixels, light of each of the plurality of pixels in a pixel unit of the plurality of pixel units may be dispersed to a different viewpoint, and the resolution of each of the plurality of viewpoint images may be reduced in both a column direction and a row direction as compared to the generated image.

The mask portion may include a plurality of mask areas, and each of the plurality of mask areas may correspond to one of the plurality of pixel units.

The plurality of mask areas may be arranged to mask half of each pixel of the plurality of pixels in a vertical direction, and the mask areas may be arranged to mask alternating halves of sequential pixels in a column direction.

The plurality of mask areas may be arranged to mask a portion of each pixel of the plurality of pixels in a diagonal direction.

The parallax portion may include a lenticular lens array.

According to another aspect of an exemplary embodiment, there is provided a multi-viewpoint image display device, including: an image panel including a plurality of pixels arranged in a matrix and divided into a plurality of pixel units; a mask portion configured to mask a portion of each pixel of the plurality of pixels; and a parallax portion arranged in front of the mask portion and configured to generate a plurality of images by dispersing light of each pixel in a pixel unit of the plurality of pixel units to a different viewpoint, wherein each of the plurality of pixel units may include at least a 2×2 pixel matrix.

According to aspects of one or more exemplary embodiments, the loss of resolution is appropriately dispersed in the vertical and horizontal directions while the multi-viewpoint image is provided, and thus the deterioration of the picture quality can be prevented.

### BRIEF DESCRIPTION OF DRAWINGS

The above and/or other aspects will be more apparent by describing certain exemplary embodiments with reference to the accompanying drawings, in which:

FIG. 1 is a view illustrating the configuration of a non-glasses type 3D display device in the related art;

FIG. 2 is a view illustrating a configuration of a multi-viewpoint image display device according to an exemplary embodiment;

FIGS. 3 to 6 are views illustrating configurations of mask patterns according to various exemplary embodiments;

FIG. 7 is a view illustrating a detailed configuration of a multi-viewpoint image display device;

FIG. 8 is a view illustrating a detailed view of a mask portion;

FIG. 9 is a view illustrating a detailed configuration of the multi-viewpoint image display device according to an exemplary embodiment;

FIG. 10 is a view illustrating an operation of a mask pattern;

FIG. 11 is a view illustrating a method for displaying a multi-viewpoint image on an image panel having a color filter;

FIG. 12 is a view illustrating an operation of a multi-viewpoint image display device according to an FSC method;

FIG. 13 is a view illustrating a method for displaying a multi-viewpoint image using a plurality of pixels;

FIG. 14 is a view illustrating a multi-viewpoint image displayed by the method of FIG. 13;

FIG. 15 is a view illustrating a multi-viewpoint display method according to an FSC method; and

FIG. 16 is a view illustrating a configuration of a mask portion according to an exemplary embodiment.

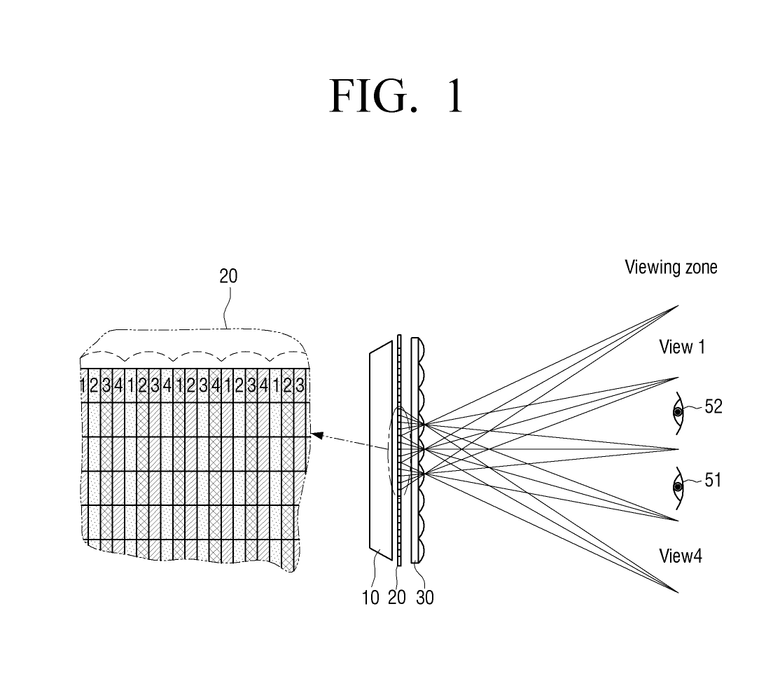

### DETAILED DESCRIPTION OF EXEMPLARY EMBODIMENTS

Hereinafter, exemplary embodiments will be described in more detail with reference to the accompanying drawings, in which like reference numerals correspond to like elements throughout.

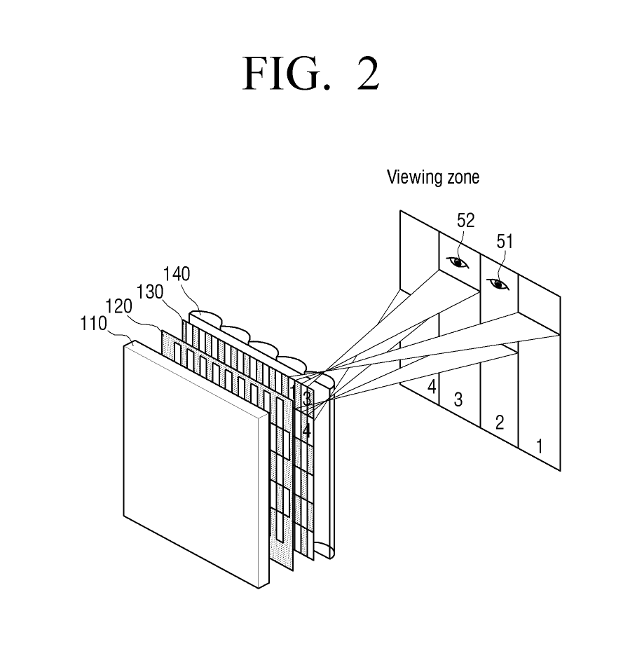

FIG. 2 is a view illustrating a configuration of a multi-viewpoint image display device according to an exemplary embodiment. The multi-viewpoint image display device of FIG. 2 is a device that performs a stereoscopic display in a non-glasses method. The multi-viewpoint image display device of FIG. 2 may be implemented by various types of display devices, such as TVs, monitors, mobile phones, PDAs, set-top PCs, tablet PCs, digital photo frames, and kiosks

Referring to FIG. 2, the multi-viewpoint image display device includes a backlight unit 110, a mask portion 120, an image panel 130, and a parallax portion 140.

The backlight unit 110 provides light in the direction of the image panel 130. The backlight unit 110 may be a direct type and/or an edge type unit depending on where light emitting elements are positioned. According to the direct type, the light emitting elements are uniformly arranged behind the rear surface of the image panel 130 to directly emit light to the image panel 130. By contrast, according to the edge type, the light emitting elements are arranged on the edge sides of the backlight unit 110 to reflect light in the direction of the image panel 130 using a light guide plate.

The backlight unit 110 may be a backlight unit that is typically applied to the LCD panel or a color sequential backlight unit that is applied to a Field Sequential Color (FSC) LCD display. That is, the type of the backlight unit 110 may differ depending on the type of the image panel 130.

The image panel 130 includes a plurality of pixels arranged in a plurality of rows and columns. The image panel 130 may be implemented by an LCD panel, and each of the plurality of pixels may be implemented by a liquid crystal cell. If light generated from the backlight unit 110 is incident to the respective pixels of the image panel 130, the image panel 130 adjusts the transmission rate of the light incident to the pixels in accordance with an image signal, and displays an image. Specifically, the image panel 130 includes a liquid crystal layer and two electrodes that are formed on both surfaces of the liquid crystal layer. If a voltage is applied to the two electrodes, an electric field is generated to move molecules of the liquid crystal layer, and thus the transmission rate of the light is adjusted. The image panel 130 divides the respective pixels by columns, and drives the respective pixel columns so that different viewpoint images are displayed for the respective columns.

The image panel 130 may be a panel having a color filter, or a panel that operates in a Field Sequential Color (FSC) driving method. The FSC driving method may be referred to as a field sequential method or a color sequential driving method. The FSC driving method is a method of temporarily dividing Red (R), Green (G), and Blue (B) lights and sequentially projecting the divided lights without using a color filter.

The parallax portion 140 is arranged in front of the image panel 130 to disperse the light that is emitted from the image panel 130 to different viewing areas. Accordingly, light that corresponds to different viewpoint images is emitted to corresponding viewing areas. The parallax portion 140 may be implemented by a parallax barrier or a lenticular lens array. The parallax barrier is implemented by a transparent slit array including a plurality of barrier areas. Accordingly, the parallax barrier operates to emit different viewpoint image lights by viewing areas through blocking of the light through the slits between the barrier areas. The width and pitch of the slit may be differently designed depending on the number of viewpoint images included in the multi-viewpoint image and the viewing distance. The lenticular lens array includes a plurality of lens areas. Each lens area is formed with a size that corresponds to at least one pixel column, and differently disperses the light transmitting the pixels of the respective pixel columns by viewing areas. Each lens area may include a circular lens. The pitch and the curvature radius of the lens may be differently designed depending on the number of viewpoint images and the viewing distance from the display device.

FIG. 2 illustrates the parallax portion 140 being implemented by a lenticular lens array, but is not limited thereto.

The parallax portion 140 is arranged to coincide with the column direction of the respective pixels provided on the image panel 130.

The mask portion 120 partially masks the respective pixels of the image panel 130. Specifically, the mask portion 120 is arranged between the backlight unit 110 and the image panel 130 to partially block the light incident to the respective pixels. The mask portion 120 is divided into a plurality of mask areas.

The mask portion 120 may be arranged as close as possible to the rear surface of the image panel 130. The mask portion 120 may be formed on the rear surface of the image panel 130 or may be arranged on the rear surface side of the image panel 130 in a state where the mask portion 120 is formed on a separate substrate. The light-transmitting area may be made through etching of a layer of an opaque material, such as metal, laminated on a glass substrate. The mask portion 120 does not serve as a parallax barrier.

The mask portion 120 may be implemented to have various shapes according to the exemplary embodiments.

Through the mask portion 120, the parallax portion 140 may provide selective viewing of the respective pixels. That is, the mask portion 120 makes the light that corresponds to a part of different viewpoint images be emitted to the side of the parallax portion 140 through partially masking the plurality of pixels that belong to the same column on the image panel 130. The parallax portion 140 provides an image which is focused on a position that is a predetermined distance from the parallax portion, i.e., a viewing distance. The position where the image is formed is called a viewing area. In FIG. 2, four viewing areas 1, 2, 3, and 4 are illustrated. Accordingly, if a user's left eye 51 is positioned in the viewing area 2 and the user's right eye 52 is positioned in the viewing area 3, the user can experience a 3D effect. By contrast, the eye that is positioned in the viewing area 3 can view the image displayed at number 3, but is unable to view other images. The eye has similar characteristics in other viewing areas. On the other hand, since the parallax portion 140 is arranged along the column direction, it is unable to exert an influence in the vertical direction, and the viewing area is extended in the horizontal direction. Since the parallax portion 140 is arranged along the pixel columns of the image panel 130, left and right crosstalk does not occur in the display device.

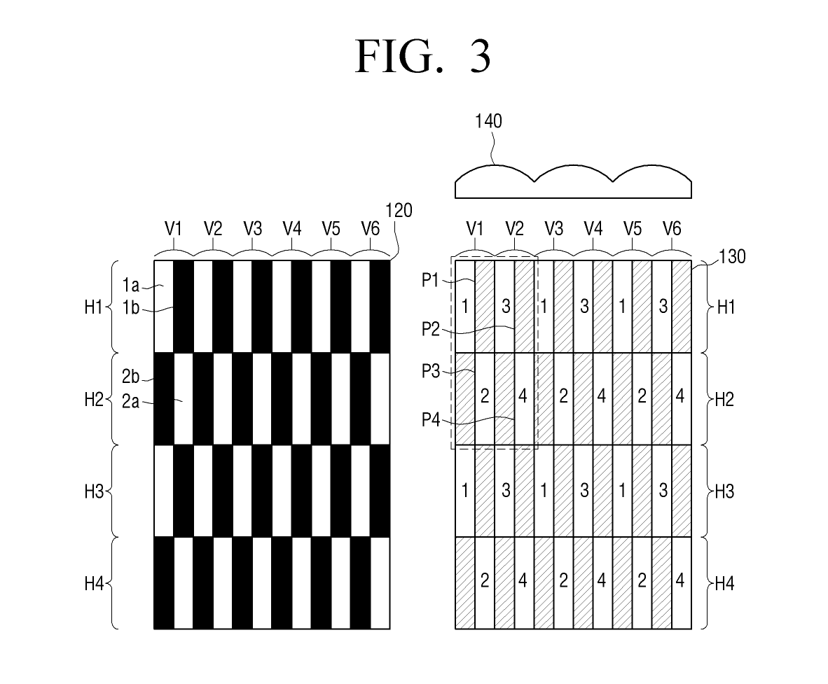

FIGS. 3 to 6 are views illustrating various configuration of the mask portion according to the exemplary embodiments.

FIG. 3 illustrates the configuration of the mask portion 120, and corresponding image panel 130 and parallax portion 140 according to an exemplary embodiment. As illustrated, the mask portion 120 includes a plurality of mask areas that are arranged in a plurality of rows H1, H2, H3, and H4 and columns V1 to V6. Each mask area includes a light-transmitting area and a light-blocking area. According to FIG. 3, each mask area is divided in the vertical direction, and thus is divided into the light-transmitting area and the light-blocking area. Further, the light-blocking area is arranged in a zigzag arrangement with respect to the pixels arranged in the row direction. Specifically, in the mask area that is positioned at row H1 and column V1, the light-transmitting area 1a is arranged on the left side, and the light-blocking area 1b is arranged on the right side. In the mask area positioned at row H2 and column V1, the light-transmitting area 2a is arranged on the right side, and the light-blocking area 2b is arranged on the left side. In FIG. 3, the light-blocking area 1b or 2b of the mask portion 120 has a size of one half of the corresponding pixel, and the light-transmitting area 1a or 2a has a size of the other half of the corresponding pixel.

In FIG. 3, the image panel operates according to the configuration of the mask portion 120. According to FIG. 3, in the image panel 130, four pixels P1, P2, P3, and P4, that are positioned in 2×2 matrix, indicate different viewpoint images. Each pixel corresponds to the size of one mask area. Further, each lens area of the parallax portion 140 that is implemented by the lenticular lens array has a size that corresponds to two pixel columns V1&V2, V3&V4, etc. As illustrated as FIG. 3, the image panel 130 displays a multi-viewpoint image by combining the plurality of pixels included in the plurality of continuous rows and columns. According to FIG. 3, four pixels included in two rows and two columns display images of viewpoints 1, 2, 3, and 4. In this case, the right half area of the pixels P1 and P2 of row H1 is masked, and the left half area of the pixels P3 and P4 of row H2 is masked. Accordingly, the light corresponding to the images is emitted through the non-masked areas in the respective pixels. The non-masked areas appear to be arranged in the order of a checker board pattern. That is, as illustrated in FIG. 2, four pixel light bundles are formed in the viewing area.

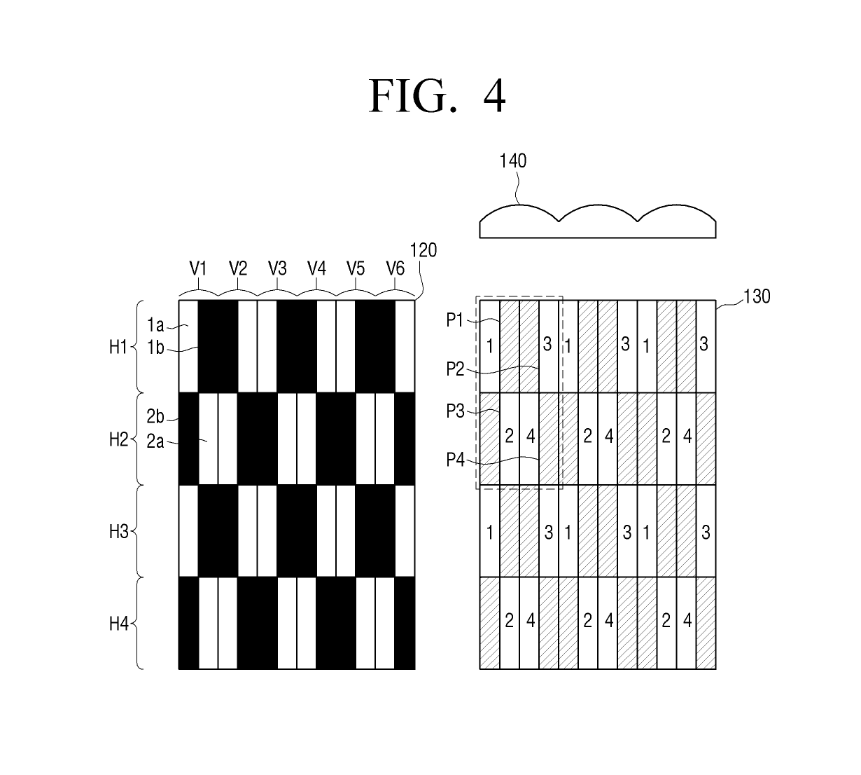

FIG. 4 illustrates another configuration example of the mask portion according to an exemplary embodiment. According to FIG. 4, the mask portion 120 includes a plurality of mask areas that are arranged in the plurality of rows H1, H2, H3, and H4 and columns V1 to V6. Each mask area includes a light-transmitting area and a light-blocking area. According to FIG. 4, each mask area of the mask portion 120 is divided in the vertical direction, and thus is divided into light-transmitting areas 1a and 2a and light-blocking areas 1b and 2b. Further, the light-blocking areas are arranged in a zigzag arrangement with respect to the pixels arranged in the row direction. Further, the positions of the light-blocking areas differ by columns. That is, as illustrated as FIG. 4, the direction of the zigzag arrangement of the light-blocking areas may be reversed for the respective columns of the mask areas. Accordingly, in the column V1, the light-blocking areas are arranged in the order of right, left, right, and left, and in the column V2, the light-blocking areas are arranged in the order of left, right, left, and right.

In FIG. 4, image panel 120 operates according to the configuration of the mask portion 120 as shown as FIG. 4. According to FIG. 4, images of viewpoints 1, 2, 3, and 4, are displayed by four pixels P1, P2, P3, and P4, dispersed and arranged through row H2 and column V2. Accordingly, 4-view display is possible.

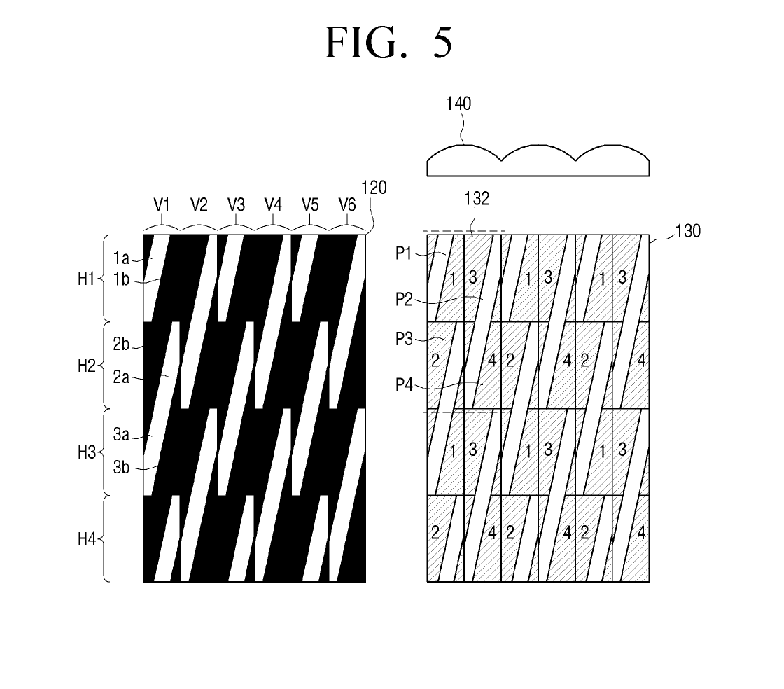

FIG. 5 illustrates still another configuration example of the mask portion according to an exemplary embodiment. According to FIG. 5, the mask portion 120 includes a plurality of mask areas that are arranged in the plurality of rows H1, H2, H3, and H4 and columns V1 to V6. Each mask area includes a light-transmitting area and a light-blocking area. In the mask area, the light-transmitting areas 1a, 2a, and 3a are formed in a diagonal direction, and the light-blocking areas 1b, 2b, and 3b are formed in the remaining areas.

Referring to FIG. 5, at least two mask areas that are arranged one by one in the row direction, among the plurality of mask areas, are connected in a diagonal direction. That is, the light-transmitting areas 2a and 3a at rows H2 and H3 and column V1 are connected to each other, and the light-transmitting areas at the next row and the row after next are connected to each other. However, such connections are not limited to those illustrated in FIG. 5, and each light-transmitting area may be formed in a diagonal direction for one mask area.

According to FIG. 5, in the image panel 130, different viewpoint images are displayed on four pixels P1, P2, P3, and P4 that are included in two rows and two columns. A part of each image is masked by the light-blocking area, and only a part of the light is emitted to the viewer side.

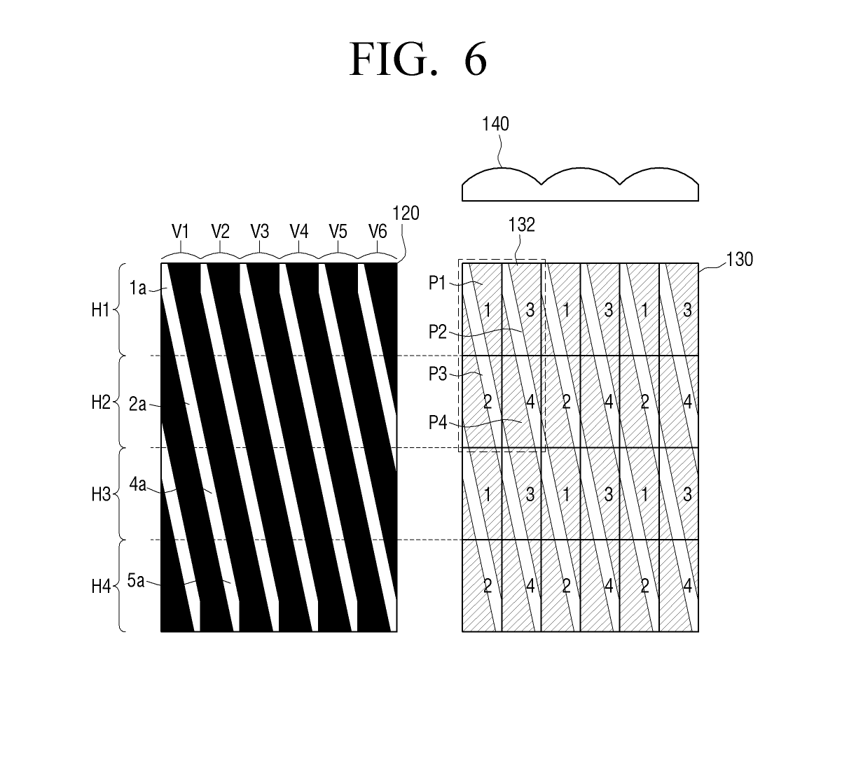

FIG. 6 illustrates still another configuration example of the mask portion according to an exemplary embodiment. According to FIG. 6, in the same manner as in FIG. 5, the light-transmitting areas are formed in a diagonal direction in the respective mask areas, and in particular, the light-transmitting areas are continuously connected in the row direction. According to FIG. 6, the light-transmitting areas 1a and 2a in the mask area that is positioned at first and second rows of the first column are connected to the light-transmitting areas 4a and 5a of the mask area that is positioned at the third and fourth rows of the second column.

According to FIG. 6, in the image panel 130, images of different viewpoints 1, 2, 3, and 4 are displayed on four pixels P1, P2, P3, and P4 that are dispersed in two rows and two columns.

In FIGS. 5 and 6, an inclination angle of the light-transmitting area in the mask area may be diversely set. As an example, the inclination angle θ may be calculated using the following equation.

θ=A tan(Pₕ/(NPᵥ))

Here, Pₕ denotes a horizontal pitch of the image panel, Pᵥ denotes a vertical pitch of the image panel, and N denotes the number of rows in a basic set of pixels. In FIGS. 3 to 6, only four rows and six columns are illustrated. However, this is for convenience in explanation, and a larger number of rows and columns may be applied to an actual product.

FIGS. 3 to 6 illustrate that the parallax portion 140 is implemented by a lenticular lens array. As described above, for example, in order to display four views on the image panel 130, the panel is divided in a vertical direction into units that are 2×2 pixels. Two upper pixels belong to view 1 and view 3, respectively, and two lower pixels belong to view 2 and view 4, respectively. The mask portion 120 partially masks the respective pixels. As a result, parts of four pixels are dispersed without overlapping. The lenticular lens array disperses the light emitted from the parts of the pixels. As illustrated, the viewing areas are illustrated in the form of four rectangles which are numbered as 1 to 4. As a result, if the original resolution of the panel is 1024×768 (XGA), each of four views may be displayed with the resolution of 512×384. That is, reduction of the resolution is dispersed to the vertical resolution and the horizontal resolution. Further, since the lenticular lenses are arranged along the pixel columns and the illuminated half pixel area does not overlap vertical projection, no interference occurs between the respective views.

As described above, the parallax portion 140 may be implemented by a parallax barrier. The parallax barrier may have a structure in which the plurality of barrier areas are arranged in the column direction. In this case, the width of the barrier area may be a size that corresponds to the size of the plurality of pixels. Since the operation in the exemplary embodiment where the parallax portion 140 is implemented by the parallax barrier is similar to the operation of the display device having the lenticular lens array as described above, the duplicate explanation and illustration will be omitted.

As described above, the image panel 130 may be a panel having a color filter, or may be a panel that operates in the FSC driving method.

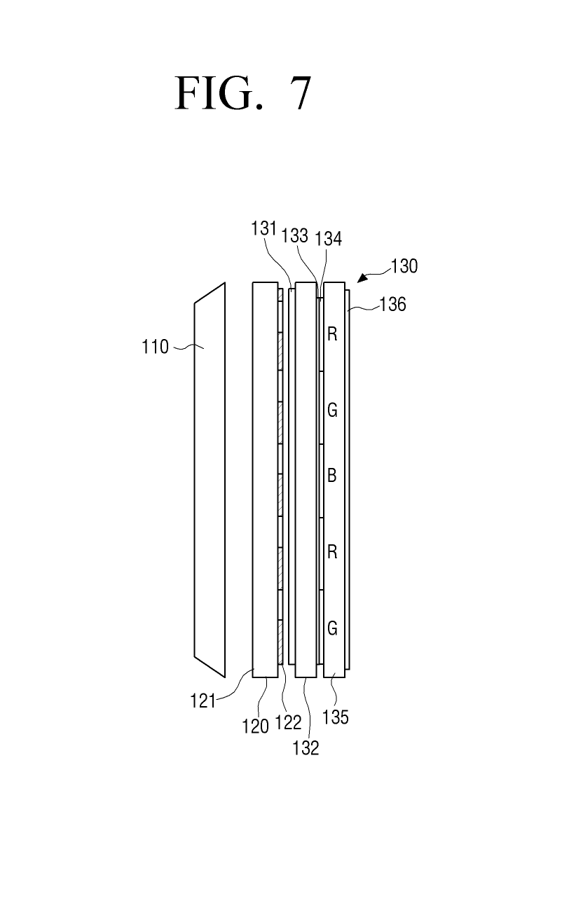

FIG. 7 illustrates the configuration of a display device having the color filter. FIG. 7 is a cross-sectional view as seen from the upper side of the display device to the lower side thereof. Although the parallax portion 140 is omitted in FIG. 7, the parallax portion may be formed on the front surface of the image panel 130.

Referring to FIG. 7, the image panel 130 includes a rear polarizer 131, a rear surface 132, a liquid crystal layer 133, a color filter 134, a front substrate 135, and a front polarizer 136.

If white light, which is emitted from the backlight unit 110 and penetrates the mask portion 120, is incident to the rear polarizer 131, the rear polarizer 131 passes only the light in a predetermined polarization direction. The penetrating light is changed to a light having different attributes depending on the transmission rate of the respective liquid crystals and the color value as the light passes through the rear substrate 132, the liquid crystal layer 133, the color filter 134, and the front substrate 135, and then is emitted through the front polarizer 136. The emitted light is dispersed by the parallax portion and is provided to a plurality of viewing areas.

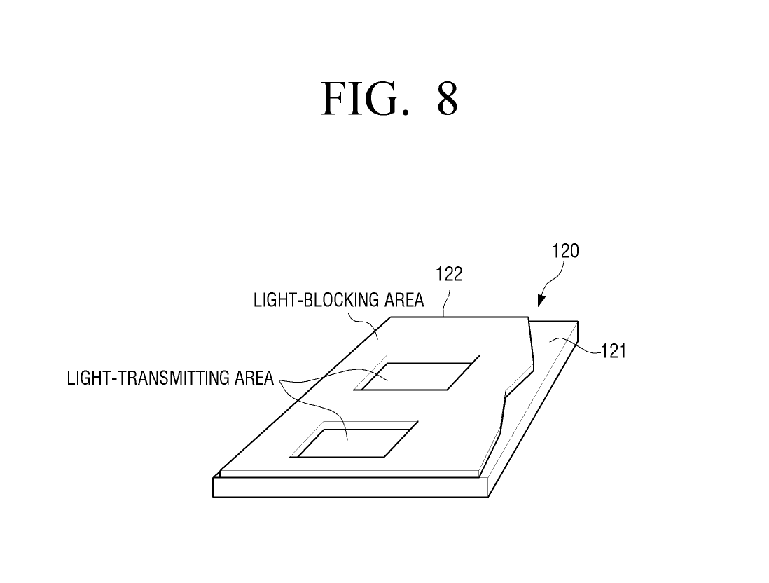

Further, the mask portion 120 includes a mask substrate 121 and a mask pattern 122. The detailed shape of the mask portion 120 is shown in FIG. 8. Referring to FIG. 8, the mask pattern 122 is formed on the surface of the mask substrate 121 where a predetermined area thereof is open. As illustrated in FIGS. 3 to 6, the size, shape, and position of the open area may be differently determined according to the various exemplary embodiments. The respective light-transmitting areas may be filled with a transparent material.

If the number of light-transmitting areas is counted in the horizontal direction, it may be equal to or larger than the number of pixel columns of the image panel. The horizontal size of the light-transmitting area is smaller than the horizontal size of the pixel of the image panel. For example, as illustrated in FIGS. 3 and 4, it may correspond to the size of about a half of the pixel. Further, the images that correspond to four viewpoints may be displayed on the LCD panel so that the images are arranged on a 2×2 pixel group having two rows and two columns, as illustrated in FIGS. 3 to 6. This arrangement is different from the arrangement in the related art on the point of the corresponding pixel arrangement. According to the pixel arrangement for expressing 4-viewpoint images in the related art, the horizontal resolution is reduced to ¼, and thus the picture quality is deteriorated. However, according to the 2×2 pixel arrangement according to the exemplary embodiments, the vertical and horizontal resolutions are respectively reduced to ½, and thus the degree of deterioration of the picture quality can be reduced in comparison to that in the related art. The number of light-transmitting areas may be equal to the number of pixels, or may be designed as a value obtained by multiplying the number of pixels by a predetermined natural number.

As illustrated in FIGS. 5 and 6, the light-transmitting areas may be aligned along a line in a state where the light-transmitting areas are inclined at a predetermined angle with respect to the respective pixel columns of the image panel. The light-transmitting areas, which are arranged along the same line, may be united into a transparent line. The number of lines may be equal to the number of the respective pixel columns of the image panel 130. Further, the number of lines may be determined according to the number of 3D views and the arrangement of the image pixels.

On the other hand, in order to partially recycle the light, the light emitted from the backlight unit 110 may be reflected to the backlight unit 110 by the opaque area of the mask 121, that is, the light-blocking area, to be recycled. The details thereof will be described later.

Various sizes and shapes of the respective constituent elements of the image panel 130 may be set. For example, the color filter 134 may have a thickness of 0.4 to 0.7 mm. The rear polarizer 131 and the front polarizer 136 may be implemented in the form of a film having a thickness of 0.15 to 0.2 mm.

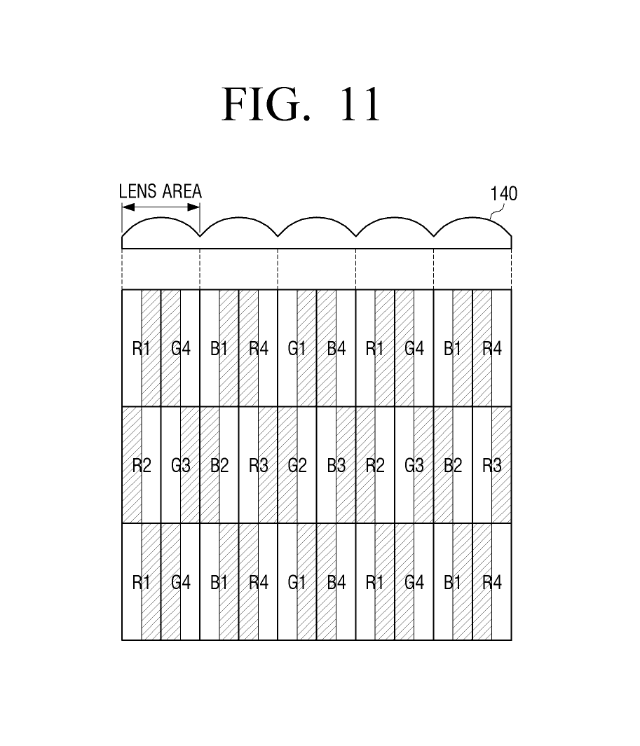

The color filter 134 is a configuration using an RGB color filter that is adopted in the case where the image panel 130 is not of a color sequential type. Data mapping by colors using the color filter 134 is illustrated in FIG. 11. Color pixels that correspond to the color columns are indicated as R, G, and B.

In order to reduce the distance between the mask pattern 122 and the pixel plane, the mask portion 120 is coupled so that the surface of the mask substrate 121, on which the mask pattern 122 is formed, faces the rear surface of the image panel 130.

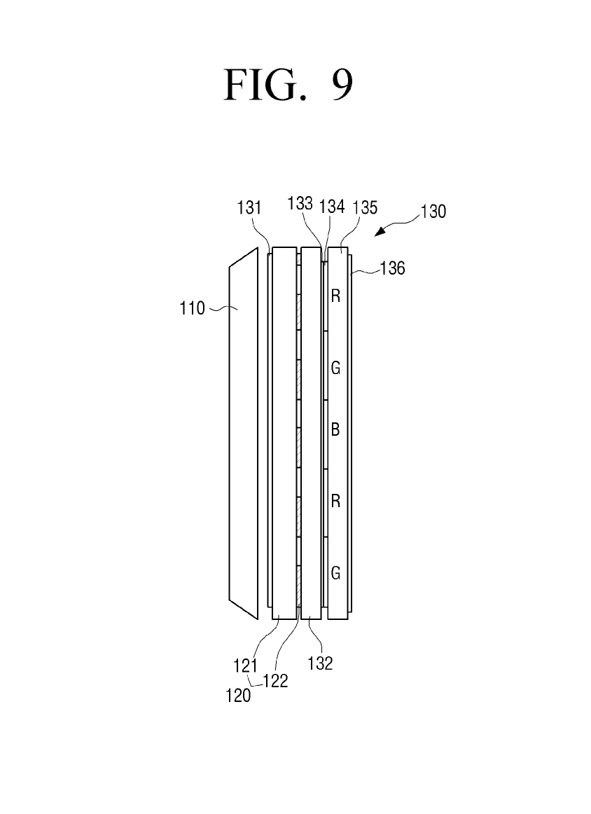

In order to further reduce the distance between the mask pattern 122 and the pixel plane, the mask portion 120 may be mounted inside the image panel 130. An example of such a configuration is illustrated in FIG. 9.

Referring to FIG. 9, the rear polarizer 131 is arranged next to the backlight unit 110, and then the mask portion 120 is arranged next to the rear polarizer 131. Thereafter, the rear surface 132, the liquid crystal layer 133, the color filter 134, the front substrate 135, and the front polarizer 136 may be sequentially arranged. Accordingly, the gap between the mask pattern 122 and the liquid crystal layer 133 can be minimized.

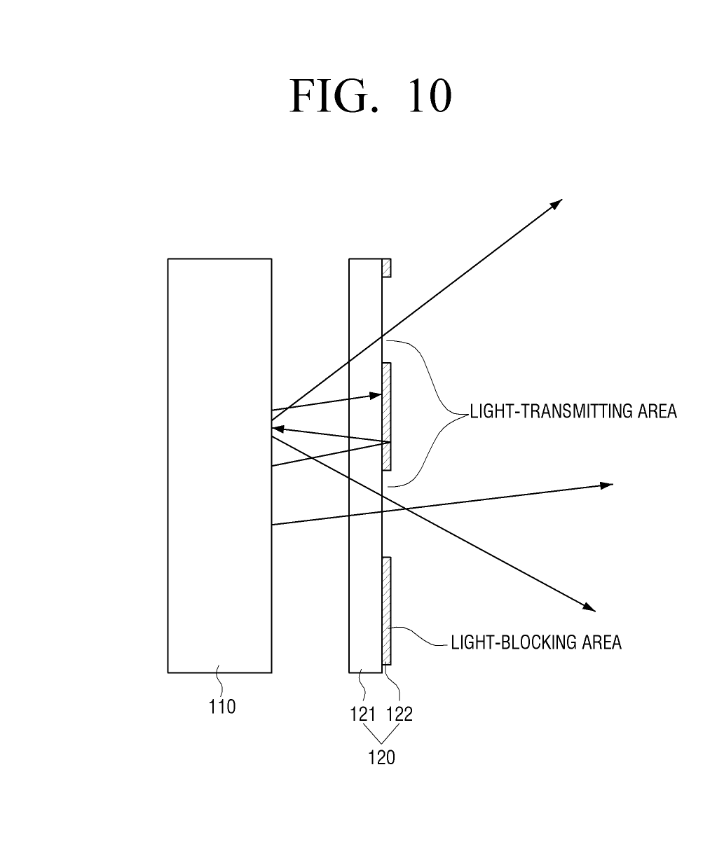

FIG. 10 is a view illustrating a configuration example of the mask portion 120 for recycling light. Referring to FIG. 10, the mask portion 120 includes a mask substrate 121 and the mask pattern 122.

Of the light emitted from the backlight unit 110, the light that is directed to the light-transmitting area in the mask pattern 122 passes through the light-transmitting area, and the light that is directed to the light-blocking area is reflected to the backlight unit 110. Accordingly, the mask pattern 122 may be made of a material having high reflection rate, or a reflection layer that is made of a material having high reflection rate may be formed on the junction surface between the mask pattern 122 and the mask substrate 121. For example, aluminum may be used.

The light that is reflected by the mask pattern 122 is dispersed by the backlight unit 110, and forms secondary light. A part of the secondary light is incident to the light-transmitting area to reduce a light loss due to the mask pattern 122.

Further, in the case where a reflective polarizer (not illustrated) is used for the light-transmitting area of the mask pattern 122, the light loss is reduced. The reflective polarizer can reflect the light having polarization that is not used in the LCD display. The polarization of the reflected light becomes extinct in the backlight by the scattering, and thus the light that is incident again to the mask has an appropriate polarization and quantity of light.

FIG. 11 shows an example of a method for mapping color data by pixels in the image panel 130 having a color filter. In FIG. 11, the parallax portion 140 is implemented by a lenticular lens array. The lenticular lens array has a plurality of lens areas, each of which has a size corresponding to two pixel columns.

The image panel 130 displays data of different colors with respect to four pixels that are dispersed in two pixel columns and two pixel rows. Accordingly, R, G, and B are uniformly provided with respect to the same viewing area. That is, in the first row, R1, B1, and G1 are respectively displayed on the pixels of the first, third, and fifth pixel columns. R1, B1, and G1 are provided to one of the plurality of viewing areas. For example, in an environment as shown in FIG. 2, if it is assumed that the pixels that display R1, B1, and G1 are provided to the viewing area 3, the user's right eye 52 that is positioned in the viewing area 3 recognizes one color image by the R1, B1, and G1 pixels.

As described above, the image panel 130 may be implemented in the form that does not have a color filter. In order to provide a color image without the color filter, the backlight unit 110 may operate in the FSC method.

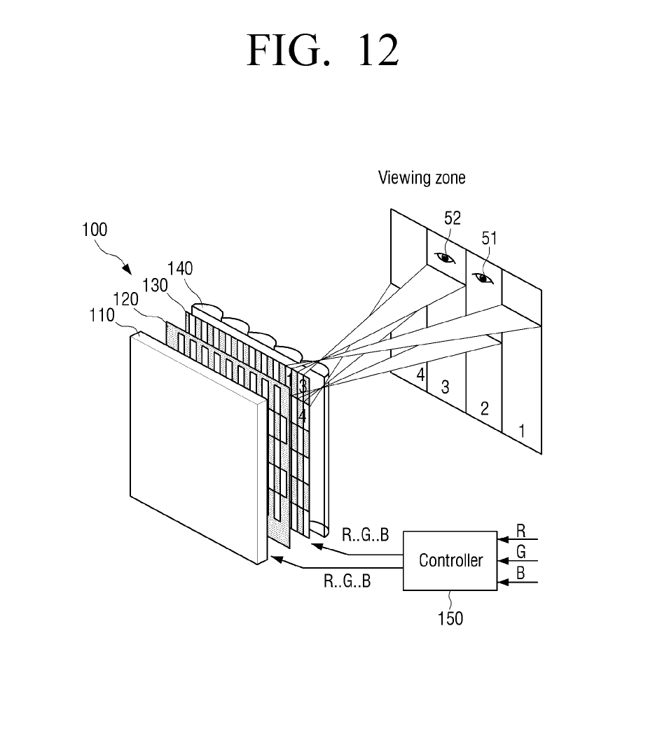

FIG. 12 is a view illustrating the configuration of a display device driven in the FSC method. Referring to FIG. 12, the display device 100 further includes a controller 150 for controlling the FSC driving.

The controller 150 receives parallel RGB data, and sequentially provides color signals for each pixel to the image panel 130. In the FSC method, the controller 150 controls the image panel 130 to sequentially display the color signals for each pixel.

Further, the controller 150 controls the backlight unit 110 to provide a plurality of different color lights, that is, R, G, and B lights to the pixels in the image panel 130 in synchronization with the display operation of the image panel 130. Accordingly, a color image can be realized using a light source included in the backlight unit 110 without the color filter. Accordingly, it is not necessary to provide R, G, and B sub-pixels for each pixel, and as a result, the horizontal resolution can be increased to prevent the deterioration of the resolution due to the multi-viewpoint image display.

For example, in the case of a Full High Definition (FHD) panel, the horizontal resolution can be increased from 1920 to 5760. In the case of using an image panel 130 of an Ultra Definition (UD), 3840×2160 class, the FHD image having resolution of 1920×1080 can be realized even though a 12-view 3D display is performed. That is, both the 2D and 3D images can be viewed in the FHD class.

In contrast, if a 9-view 3D display is performed on the FHD panel having the resolution of 1920×1080 and having the color filter, a 640×360 resolution (Standard Definition(SD) class) image is displayed. In the case of performing a 9-view 3D display using the UD panel, a 1280×720 (High-Definition (HD) class) image is displayed. Accordingly, through driving in the FSC method, a 3D display having more viewpoints and a better resolution can be realized.

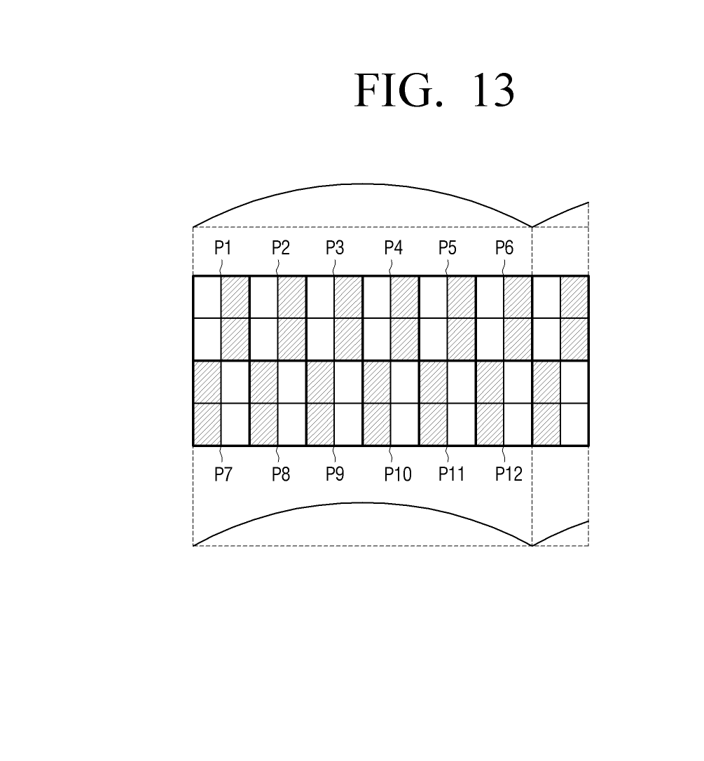

FIG. 13 illustrates a configuration example of an image panel in a display device implemented in the FSC method. Referring to FIG. 13, the parallax portion 140 is implemented by a lenticular lens array, and the width of one lens area has a size corresponding to horizontal size of 6 pixel columns.

Referring to FIG. 13, the image panel 130 provides 12-view images using 12 pixels P1 to P12 in total, which is dispersed to two pixel rows and 6 pixel columns.

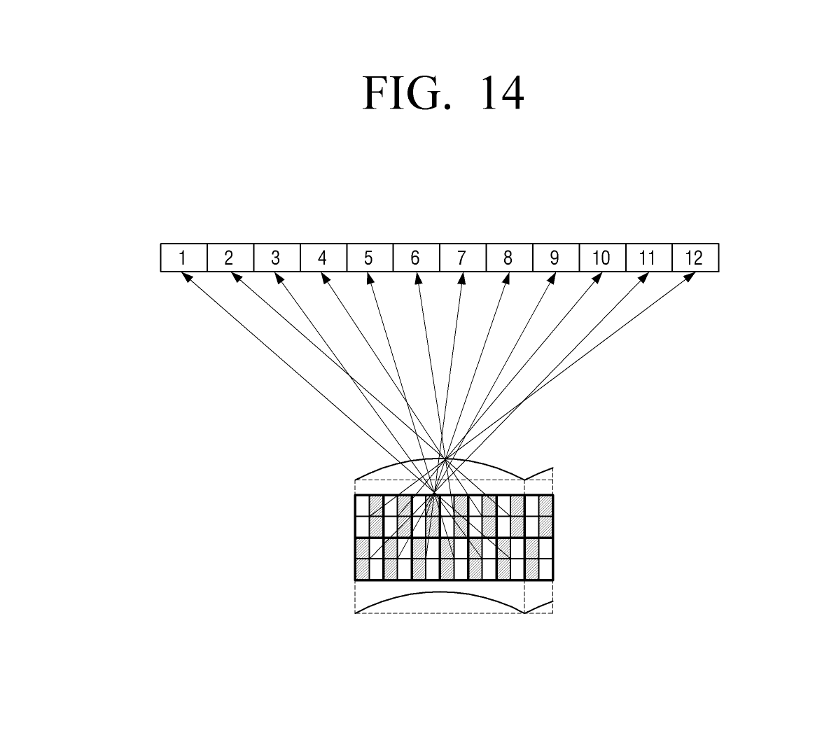

FIG. 14 illustrates an example of 12-view images. Referring to FIG. 14, the pixels P1 to P12 are masked in a zigzag form, and light that corresponds to parts of images that are displayed on the respective pixels P1 to P12 is dispersed and provided to 12 viewing areas. Accordingly, crosstalk can be reduced by viewpoints in the respective viewing areas, that is, 3D areas. As described above, the masking can be performed in various forms as shown in FIGS. 3 to 6. In the case of 2D, a 2D screen can be implemented by applying one piece of image information to 12 entire pixels. As described above, if the image panel 130 is implemented by the UD panel, from which the color filter is removed, as described above, the 2D or 3D image can be simultaneously or individually driven.

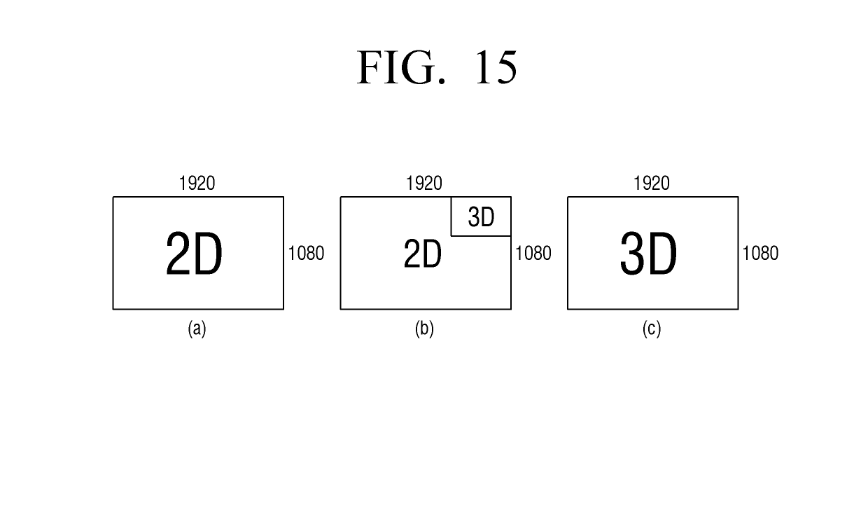

FIG. 15 illustrates views explaining various content display methods using the FSC type image panel. Referring to (a) and (c) of FIG. 15, the display device may provide 2D or 3D content with 1920×1080 resolution, or may display a multi-view as shown in (b) of FIG. 15. Specifically, as illustrated in (b) of FIG. 15, 3D content may be displayed only one area on the screen and 2D contents may be displayed on the other area in a Picture-in-Picture (PIP) method. Additionally, the 2D and 3D content may be displayed together in the opposite method.

In the above-described exemplary embodiments, the mask portion 120 is described as being arranged between the backlight unit 110 and the image panel 130, but is not limited thereto. That is, the mask portion 120 may be built in the image panel 130, or may be arranged on the front surface side of the image panel.

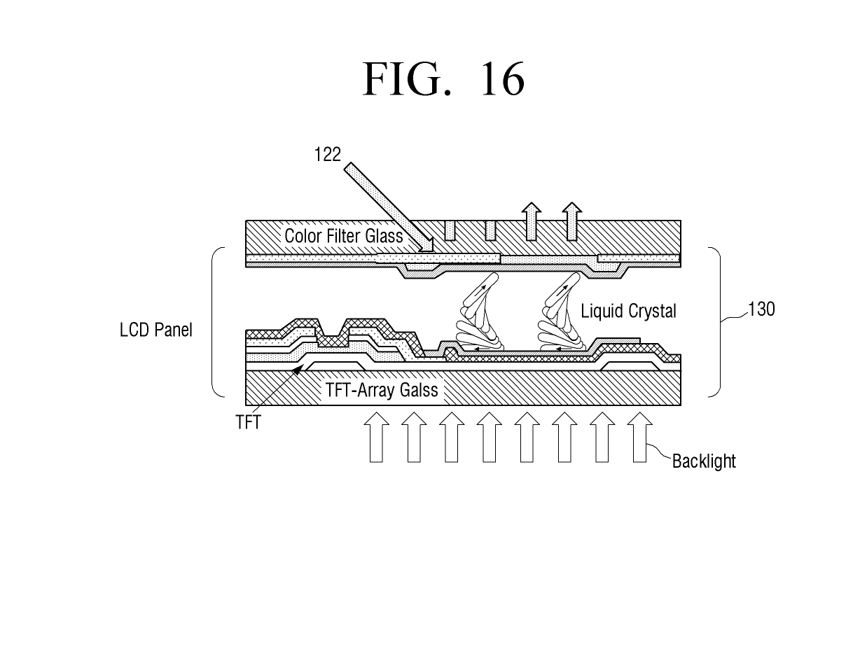

FIG. 16 illustrates the configuration of an image panel of a display device according to another exemplary embodiment. Referring to FIG. 16, the mask pattern 122 is formed on the color filter glass side in the image panel 130, and is arranged to cover only a part of the liquid crystal portion. The size and the shape of the mask may be variously changed in the exemplary embodiments illustrated in FIGS. 3 to 6. Accordingly, the light provided from the backlight unit 110 is transferred to the liquid crystals as it is, and the light projected from the liquid crystals is blocked by the mask pattern 122, so that the interference between the respective viewpoint images can be reduced. In this case, the mask pattern 122 itself corresponds to the above-described mask portion 120.

FIG. 16 illustrates that only the mask pattern 122 is built in the image panel 130. However, the mask substrate 121 may also be mounted in the image panel 130. Further, the mask portion 120 may be attached to the front surface of the image panel 130.

According to the exemplary embodiments as described above, the loss of resolution between the vertical and horizontal resolutions is dispersed, and thus the loss of resolution of only side is prevented. Further, since the light for the respective viewpoints overlap each other, the crosstalk can be prevented.

While the exemplary embodiments have been shown and described, it will be understood by those skilled in the art that various changes in form and detail may be made therein without departing from the spirit and scope of the inventive concept, as defined by the appended claims.

1. A multi-viewpoint image display device comprising:
an image panel including a plurality of pixels configured to be arranged in a plurality of rows and columns;
a backlight unit configured to provide light to the image panel;
a parallax portion configured to be arranged in front of the image panel; and
a mask portion configured to be arranged between the image panel and the backlight unit to partially mask the plurality of pixels.

2. The multi-viewpoint image display device of claim 1, wherein the mask portion comprises a plurality of mask areas configured to correspond to the plurality of pixels,
wherein each of the plurality of mask areas is divided in a vertical direction into a light-transmitting area and a light-blocking area, and
wherein the light-blocking area is arranged in a zigzag arrangement with respect to the pixels arranged in a row direction.

3. The multi-viewpoint image display device of claim 2, wherein the light-blocking area has a size of one half of a corresponding pixel, and the light-transmitting area has a size of the other half of the corresponding pixel.

4. The multi-viewpoint image display device of claim 2, wherein the plurality of mask areas are sequentially aligned as a plurality of columns, and the direction of the zigzag arrangement of the light-blocking area is alternately reversed for each of the sequential columns of the respective mask areas.

5. The multi-viewpoint image display device of claim 4, wherein the light-blocking area has a size of one half of a corresponding pixel, and the light-transmitting area has a size of the other half of the corresponding pixel.

6. The multi-viewpoint image display device of claim 1, wherein the mask portion comprises a plurality of mask areas configured to correspond to the plurality of pixels,
wherein each of the plurality of mask areas is divided into a light-transmitting area and a light-blocking area, and
wherein the light-transmitting area is formed in a diagonal direction in each of the plurality of mask areas.

7. The multi-viewpoint image display device of claim 1, wherein the mask portion comprises a plurality of mask areas configured to correspond to the plurality of pixels,
wherein each of the plurality of mask areas is divided into a light-transmitting area and a light-blocking area,
wherein the light-transmitting area is be formed to be connected in a diagonal direction in at least two of the mask areas that are arranged in parallel in a row direction among the plurality of mask areas, and
wherein the light-blocking area is formed in a remaining area except for the light-transmitting area in the mask area.

8. The multi-viewpoint image display device of claim 1, wherein the mask portion comprises a plurality of mask areas configured to correspond to the plurality of pixels,
wherein each of the plurality of mask areas is divided into a light-transmitting area and a light-blocking area, the light-transmitting area is formed in a diagonal direction in the plurality of mask areas, and
wherein the light-transmitting areas formed in the respective mask areas are connected to each other.

9. The multi-viewpoint image display device of claim 1, wherein the image panel is an Ultra Definition (UD) panel that does not include a color filter.

10. The multi-viewpoint image display device of claim 1, wherein the image panel sequentially displays color signals for each pixel according to an Field Sequential Color (FSC) method, and
wherein the backlight unit provides a plurality of different color lights to the respective pixels in the image panel in synchronization with a display operation of the image panel.

11. The multi-viewpoint image display device of claim 10, wherein the image panel displays a multi-viewpoint image by combining the plurality of pixels included in the plurality of continuous rows and columns.

12. The multi-viewpoint image display device of claim 11, wherein the image panel displays a 12-viewpoint image through a 2×6 pixel matrix by combining 6 pixels continuously arranged in a horizontal direction and two pixels continuously arranged in a vertical direction.

13. The multi-viewpoint image display device of claim 11, wherein the parallax portion comprises a lenticular lens of which a plurality of lens areas are arranged in a column direction, and
wherein a width of each of the lens areas corresponds to a width of each of the plurality of pixels.

14. The multi-viewpoint image display device of claim 11, wherein the parallax portion comprises a parallax barrier of which a plurality of barrier areas are arranged in a column direction, and
wherein a width of each of the barrier areas corresponds to a width of each of the plurality of pixels.

15. A multi-viewpoint image display device, comprising:
an image panel divided into a plurality of pixel units and configured to generate an image and comprising a plurality of pixels arranged in a matrix;
a mask portion configured to mask a portion of each pixel of the plurality of pixels; and
a parallax portion arranged in front of the mask portion and configured to generate a plurality of viewpoint images directed toward different viewpoints,
wherein each of the plurality of pixel units comprises a plurality of pixels,
wherein light of each of the plurality of pixels in a pixel unit of the plurality of pixel units is dispersed to a different viewpoint, and
wherein a resolution of each of the plurality of viewpoint images is reduced in both a column direction and a row direction as compared to the generated image.

16. The multi-viewpoint image display device of claim 15, wherein the mask portion comprises a plurality of mask areas, and
wherein each of the plurality of mask areas corresponds to one of the plurality of pixel units.

17. The multi-viewpoint image display device of claim 16, wherein the plurality of mask areas are arranged to mask half of each pixel of the plurality of pixels in a vertical direction, and
wherein the mask areas are arranged to mask alternating halves of sequential pixels in a column direction.

18. The multi-viewpoint image display device of claim 16, wherein the plurality of mask areas are arranged to mask a portion of each pixel of the plurality of pixels in a diagonal direction.

19. The multi-viewpoint image display device of claim 15, wherein the parallax portion comprises a lenticular lens array.

20. A multi-viewpoint image display device, comprising:
an image panel comprising a plurality of pixels arranged in a matrix and divided into a plurality of pixel units;
a mask portion configured to mask a portion of each pixel of the plurality of pixels; and
a parallax portion arranged in front of the mask portion and configured to generate a plurality of images by dispersing light of each pixel in a pixel unit of the plurality of pixel units to a different viewpoint,
wherein each of the plurality of pixel units comprises at least a 2×2 pixel matrix.
